(19) United States
(12) Patent Application Publication
(10) Pub. No.: US 2007/0171201 A1
(43) Pub. Date: Jul. 26, 2007

(54) Computer input device

(76) Inventors: Sharon Wang Pi, Anaheim, CA (US); Daniel John Bowen, Whittier, CA (US)

Correspondence Address: STOEL RIVES LLP - SLC, 201 SOUTH MAIN STREET, ONE UTAH CENTER, SALT LAKE CITY, UT, 84111, US

(21) Appl. No.: 11/340,236

(22) Filed: Jan. 26, 2006

(51) Int. Cl. G09G 5/08

(52) U.S. Cl. 345/157

(57) ABSTRACT

A computer input device for operating a computer system having a display and being capable of executing an application program provides a user with control of the computer and can include one or more input keys for accepting user input, control logic for converting the first user input into first control signals operable to control one or more aspects of operation of the application program, a communication mechanism for providing the first control signals to the computer, a recording device for recording audio, video and other content information and a display for providing time information relating to a timing event to the user via the pointing device.

### TECHNICAL FIELD

This invention relates to human interface input devices for computers, and in particular to a human-computer interface device with advanced operational features.

### BACKGROUND ART

At one time, lectures with graphical and/or textual aids were presented with blackboards or flip charts. Subsequently, various optical projection techniques such as “magic lanterns,” slide projectors, and later, overhead projectors were used to enhance the presentation experience. Even more recently, advances in electronic digital display technologies, such as direct view computer monitors, and projection computer monitors have become available. Such digital display technologies allow the use of software packages such as PowerPoint® by Microsoft® Corporation, or Presentations™ from Corel® Corporation, for example, to directly create, edit, and present graphical and/or text presentations, using a personal computer or the like. Typically, such software packages allow a user to create a sequence of slides or other presentation elements for presentation that include text and/or graphics that is stored in a computer file. When a presentation is to be made, the computer file is then played on a personal computer connected to a direct view or projection computer monitor, under the control of the presenter, and using a respective software presentation package, such as discussed above.

Many presenters prefer freedom from the requirement to directly actuate a personal computer using a keyboard and/or wired mouse or other captive pointing device during presentations. Rather, such presenters prefer the freedom that wireless control of the presentation on the personal computer offers, in terms of presenter's mobility and freedom of bodily expression. This preference has led to the introduction of wireless remote controls that are coupled with the PC, and can be easily handled by a presenter. Additionally, many presenters like to highlight aspects of graphical and/or textual displays being presented. As a result, wireless remote controls often incorporate laser, or other optically projected pointers for more freedom of expression in pointing.

Computer mice, presenters, and other like input devices are not limited to use with presentations. Indeed, such input devices have taken on a more central role in personal computer interaction since their introduction. The computer mouse, perhaps the most common pointing device, was popularized by its inclusion with the Apple Macintosh, which had an innovative user interface. The subsequent rise in popularity of such graphical user interfaces in MS-DOS, UNIX, and OS/2, the computer mouse, in one form or another, has steadily grown in popularity in the personal computer and workstation worlds.

### SUMMARY OF THE INVENTION

Embodiments of the present invention combine computer display control, visual pointing, presentation timing control, and voice memo functions in a compact, handheld unit for use in presentations using a personal computer for graphics and/or text display.

In accordance with one embodiment of the invention, a computer pointing device, is provided and includes a housing that can be shaped in an ergonomically desirable fashion, a pointing mechanism at least partially within the housing and configured to accept user input and to generate a first control signal to control a pointer position on a display of the computer, at least one input key at least partially extending from the housing and configured to generate a second control signal to provide an instruction to an application running on the computer, an audio transducer configured to receive audible information and to convert the audible information into first electrical signals, an audio encoder within the housing and electrically coupled to the audio transducer, the audio encoder configured to encode the electrical signals into a digitized representation of the received audible information, a memory device electrically coupled to the audio encoder and configured to store the digitized representation of the received audible information, an audio decoder configured to decode the digitized representation into second electrical signals, and a speaker, connected to the audio decoder and configured convert the second electrical signals into an audible stream of information.

The computer input device can further include a display configured to provide time information to the user of the computer input device, wherein the display can comprise at least one of an alphanumeric display, a graphical display, a numeric display, and a traffic light display.

In one embodiment, the pointing mechanism can comprise at least one of a trackball, touchpad, joystick, scroll wheel, an optical sensor and an inertial sensor. Additionally, a wired and a wireless communication interface can be included to provide communications with the computer.

In accordance with another embodiment of the invention, the computer input device can include a plurality of input keys configured to permit user interaction with one or more application programs running on a computer; a user actuated pointing mechanism configured to allow a user to control a position of a pointer on a display screen of the computer; and a recording device configured to record audio information for later playback. The input device can also include local memory configured to store recorded audio information locally to the computer input device.

In one embodiment, one or more of the features and aspects of the computer input device can be implemented using one or more elements of control logic, which can be comprised of hardware, software, or a combination thereof. Control logic may be described in terms of the functions that one or more elements of control logic perform. However, such description should not imply that the control logic configured to perform a particular function is a discrete element of control logic separate from or mutually exclusive to another element of control logic configured to perform a different or additional function. Indeed, such descriptions in logical terms do not imply a physical separation of control logic or its elements. Various portions of control logic can be implemented so as to perform individual or multiple functions.

In yet another embodiment, a computer input device for controlling operation of computer, includes means for accepting user input at the pointing device; means for converting the user input into control signals operable to control one or more aspects of an operation of the computer; means for providing the control signals to the computer; and means recording audio information via the pointing device. The input device can be further configured to include means for recording video information via the pointing device, means for storing recorded audio information at the pointing device and means for providing recorded audio information to the computer.

Additionally, a method of using an input device to control a computer, in one embodiment, comprises steps of accepting user input via user actuation of input mechanisms on the pointing device; converting the user input into control signals operable to control one or more aspects of the computer; providing the first control signals to the computer; and recording audio information via the input device. The method can further include steps of storing the recorded audio information in the input device, recording video information via the pointing device, and communicating recorded audio information to the computer.

In accordance with yet another embodiment of the invention a method of providing an interface to a computer system is provided, the computer system having a display and being capable of executing an application program configured to display presentation elements, the method allowing a user to control operation of the computer. The method in one embodiment comprises the steps of accepting first user input via one or more input keys on a pointing device; converting the first user input into first control signals operable to control one or more aspects of operation of the application program; providing the first control signals to the computer, wherein the first control signals are configured to cause the application program to transition from a presentation element to another presentation slide; determining at least one timing event associated with the presentation materials; and providing time information relating to the timing event to the user via the pointing device.

In another embodiment, the method further includes the step of accepting second user input via a pointing mechanism on the pointing device and providing second control signals responsive to the second user input configured to instruct the computer to adjust the position of a pointer on a display screen of the computer. In one embodiment the step of determining at least one timing event associated with the presentation materials comprises the step of measuring or computing total allocated presentation time, an average time for one or more presentation elements, a running presentation element average time, time remaining in a presentation, time elapsed in a presentation, an estimate of whether the user is ahead or behind in a presentation, and presentation timing milestones. In a further embodiment, the method can also include a step of illuminating an optical element to project a pointer onto a presentation screen. In still a further embodiment, the step of providing time information comprises the step of displaying the time information in a visual display located at the pointing device, wherein the visual display can be implemented at least one of an alphanumeric display, a graphical display, a numeric display, and a traffic light display; the step of providing time information comprises the step of activating at least one of an audible alert and a tactile alert upon the occurrence of a timing event; the step of determining at least one timing event associated with the presentation materials comprises the step of learning the at least one timing event during an operation of the pointing device and the user actuated pointing mechanism comprises at least one of a trackball, touchpad, joystick, scroll wheel, an optical sensor and an inertial sensor.

In accordance with another embodiment of the invention, a method of using a pointing device to control a computer, comprises accepting input via user actuation of the pointing device; converting the user input into first control signals operable to control one or more aspects of an operation of the computer; providing the first control signals to the computer; and providing time information to the user via the pointing device.

This method can further comprising the step of determining at least one timing event associated with the operation of the computer, wherein the step of determining at least one timing event associated with the operation of the computer can comprise the step of measuring or computing total allocated time, an average time for one or more operations, a running average operation time, time remaining in an operation, time elapsed in an operation, an estimate of whether an operation is ahead of or behind schedule, and operation timing milestones. Additionally, the step of determining at least one timing event associated with the presentation materials can comprise the step of learning the at least one timing event during an operation of the pointing device.

In one embodiment, the step of providing time information comprises the step of displaying the time information in a visual display located at the pointing device, wherein the visual display can comprise at least one of an alphanumeric display, a graphical display, a numeric display, and a traffic light display.

In yet another embodiment of the invention, a computer input device comprises a plurality of input keys configured to permit user interaction with one or more application programs running on a computer; a user actuated pointing mechanism configured to allow a user to control an position of a pointer on a display screen of the computer; and a display on the computer input device configured to provide time information to the user of the computer input device. The user actuated pointing mechanism can comprise at least one of a trackball, touchpad, joystick, scroll wheel, an optical sensor and an inertial sensor. Additionally, the display can comprise at least one of an alphanumeric display, a graphical display, a numeric display, and a traffic light display.

In still a further embodiment of the invention a computer mouse, comprises a plurality of input keys configured to permit user interaction with one or more application programs running on a computer; a user actuated pointing mechanism configured to allow a user to control an position of a pointer on a display screen of the computer; and a display configured to provide time information to the user of the computer input device. The computer mouse can include at least one of a wired and wireless interface to the computer, and the display can comprise at least one of an alphanumeric display, a graphical display, a numeric display, and a traffic light display.

In another embodiment of the invention, a pointing device to control operation of computer and provide timing information comprises control logic configured to accept user input at the pointing device; control logic configured to convert the user input into first control signals operable to control one or more aspects of an operation of the computer; control logic configured to provide the first control signals to the computer; and control logic configured to provide time information to the user via the pointing device. The pointing device can, further include control logic configured to determine at least one timing event associated with the operation of the computer. The control logic configured to determine at least one timing event associated with the operation of the computer can comprise control logic configured to measure or compute total allocated time, an average time for one or more operations, a running average operation time, time remaining in an operation, time elapsed in an operation, an estimate of whether an operation is ahead of or behind schedule, and operation timing milestones. The control logic configured to determine at least one timing event associated with the presentation materials can also comprise control logic configured to learn the at least one timing event during an operation of the pointing device. Additionally, the control logic configured to provide time information can comprise the control logic configured to display the time information in a visual display located at the pointing device and can comprise at least one of an alphanumeric display, a graphical display, a numeric display, and a traffic light display.

In still another embodiment, a pointing device is provided to control operation of computer and provide timing information, wherein the pointing device comprises means for accepting user input at the pointing device; means for converting the user input into first control signals operable to control one or more aspects of an operation of the computer; means for providing the first control signals to the computer; means for providing time information to the user via the pointing device, and means for determining at least one timing event associated with the operation of the computer. In one embodiment, the means for determining at least one timing event associated with the operation of the computer comprises means for measuring or computing total allocated time, an average time for one or more operations, a running average operation time, time remaining in an operation, time elapsed in an operation, an estimate of whether an operation is ahead of or behind schedule, and operation timing milestones. In one embodiment, the means for determining at least one timing event associated with the presentation materials comprises means for learning the at least one timing event during an operation of the pointing device. In another embodiment, the means for providing time information comprises the means for displaying the time information in a visual display located at the pointing device, and the display can comprise at least one of an alphanumeric display, a graphical display, a numeric display, and a traffic light display.

Further features and advantages of the present invention, as well as the structure and operation of various embodiments of the present invention, are described in detail below with reference to the accompanying drawings.

### BRIEF DESCRIPTION OF THE DRAWINGS

The present invention, in accordance with one or more various embodiments, is described in detail with reference to the following figures. The drawings are provided for purposes of illustration only and merely depict typical or example embodiments of the invention. These drawings are provided to facilitate the reader's understanding of the invention and shall not be considered limiting of the breadth, scope, or applicability of the invention. It should be noted that for clarity and ease of illustration these drawings are not necessarily made to scale.

FIG. 1 presents a high level system block diagram in accordance with one embodiment of the invention.

FIG. 2 is a block diagram illustrating an example implementation of a handheld pointing device according to one embodiment of the invention.

FIGS. 3a and 3b, respectively show front and side views of an example handheld pointing device according to one embodiment of the invention.

FIGS. 4a and 4b, respectively show front and side views of an example handheld pointing device according to one embodiment of the invention.

FIG. 5 is a diagram illustrating an example wireless interface device according to one embodiment of the invention.

FIG. 6 is a high level flow chart illustrating a learning operation in accordance with one embodiment of the invention.

FIG. 7 is an operational flow diagram illustrating an example process for learning presentation timing in accordance with one embodiment of the invention.

### DETAILED DESCRIPTION OF THE INVENTION

The present invention is directed toward an apparatus and method for combining advanced features with computer input devices to provide enhanced levels of functionality. The various embodiments of the present invention can include one or more features such as, for example, wireless computer control, optical pointing, timing functions, voice and data recording functions in a single computer pointing device such as, for example, a mouse, presenter or other pointing device.

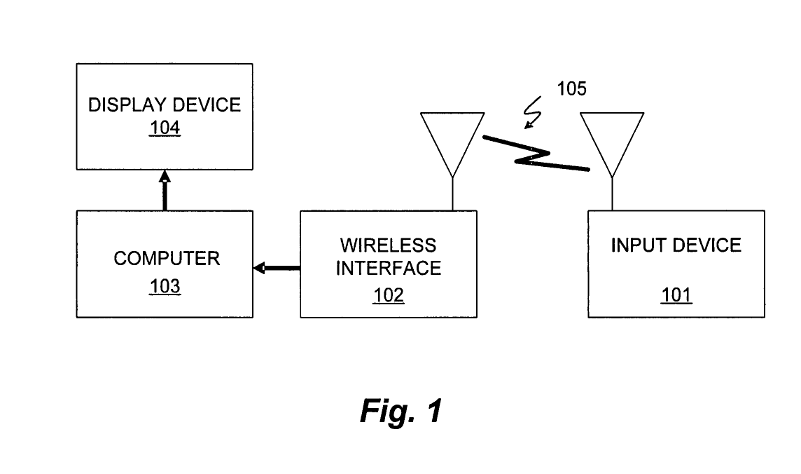

Before describing the invention in detail, it is useful to describe an example environment with which the invention can be implemented. One such example environment is a computer pointing device such as, for example, a wireless mouse that is used to control certain operations of a computer. Such pointing devices can be implemented in a number of different configurations using a number of different architectures. To facilitate description of the features and functionality of the various embodiments of the invention, the invention described in terms of the example environment of a wireless input device configured to allow a user to control the display of presentation materials with a computer display as generally depicted with reference to FIG. 1. However, it will become apparent to one of ordinary skill in the art after reading this description how to implement the various features and functionality of the present invention in alternative environments or with alternative devices or architectures.

FIG. 1 is a block diagram illustrating an example environment which the present invention can be implemented. This example environment is that of a wireless computer input device 101 used to control operations of a computer 103. In this environment, an input device 101 may be provided as a human interface to allow humans to interact with computer 103. Computer 103 can be any of a number of processing or computing devices including, for example, laptop computers, desktop computers and workstations. However, computer 103 is not limited to these traditional computing devices and can further include now or later developed computer devices of any character. For example, computer 103 can be a handheld or palmtop computing device such as, for example, a PDA, smartphone, Pocket PC, tablet computer, and other like computing devices. Further examples can also include special purpose devices such as GPS devices, MP3 players, and the like. In other words, computer 103 can also be either a general purpose computing device or a special purpose computing device. As these examples serve to illustrate, the term “computer” as used in this document is intended to mean be any device capable of managing, processing, storing, or otherwise operating with data and other information.

In one embodiment, input device 101 can be implemented as a mouse, trackball, joystick, or other pointing or input device. Input device 101 can also encompass a keyboard, keypad or other like input device. In one embodiment, input device 101 can control certain features and functions of the computer and the applications or the operating system running thereon such as, for example, x-y or x-y-z pointer positioning, scrolling, selection, and other like pointing features typically associated with a conventional computer mouse or a trackball.

Additionally, enhanced input features can be included with the input device 101 such as dedicated or soft-selectable buttons or switches to allow additional user input to control the operations of computer 103. For example, buttons or switches can be included to control the playback features of a media player such as volume up and down controls, pause/play controls and so on. Likewise, page-up and page-down controls to control a presentation mode, web browsing controls such as forward and back buttons, and other operational features may be included as desirable to control a multitude of different applications from an input device 101. In one embodiment, input devices such as computer mouse products, presenters and other pointing devices including those available from Targus® and other companies can be modified or configured to include the timing, display, recording and other features described herein. However, application of the invention is not limited to use with conventional input devices and the features and functionality of the invention can be incorporated into any input device now or later developed in accordance with the teachings provided herein.

In operation, input device 101 typically accepts user input and converts the user input into control signals that control one or more aspects of the computer 103 (or a program running thereon). Using the examples provided above, key or button actuations result in control signals being generated and sent to the computer to cause the computer to perform the functions associated with the particular keystrokes such as, for example, cursor positioning, page-up and page-down controls, volume up an volume down controls, scrolling, and other actions. Likewise, motion inputs from a pointing mechanism such as a trackball, joystick, mouse movement, or other mechanism result in control signals that cause the program to perform operations such as, for example, adjust the screen position of a pointer.

In the embodiment illustrated in FIG. 1, input device 101 communicates with computer 103 via a wireless communication connection 105. The air interface 105 can be implemented in a variety of ways that are well known to one of ordinary skill in the art, for example without exclusion, BlueTooth®, IRDA®, IEEE 802.11a, IEEE 802.11b, IEEE 802.11g, IEEE 802.11n, as well as various proprietary analog and transmission formats that typically operate in the 2.4 GHz ISM band. Wireless interface 102 can be operatively coupled to computer 103 in a variety of ways that are well known to one of ordinary skill in the art, for example without exclusion RS232, USB 1.0®, and USB 2.0®. In other embodiments, hardwired interfaces can be provided between input device 101 and computer 103 to allow the exchange of information and control signals between input device 101 and computer 103.

In some embodiments of the invention, computer 103 would typically run an operating system as well as various application programs. For example, if used for giving presentations software packages such as PowerPoint® by Microsoft® Corporation, or Presentations™ from Corel® Corporation can be included with computer 103. Such software packages typically allow a user to prepare various presentation elements such as slides or other presentation elements, and to advance (or reverse) among the presentation elements being displayed in response to user inputs. Such user inputs can include, for example, key actuations on a keyboard or keypad, the actuation of buttons, switches or other keys associated with input device 101 or other user actions. As such, a user's actuation of a mouse, trackball or other input device 101 can be used to advance to the next, or go back to the previous, slide or other presentation element being presented using the display device 104. The user's actuation can also, in some embodiments control the volume or muting of sound elements, tone control, the location of pointers on the display, video control and playback features, as well as other features associated with a given application.

Display device 104 can be a computer screen or monitor such as, for example, a CRT, LCD, Plasma, or other type of direct display, whether desktop, wall-mounted or otherwise. Display device 104 can also be implemented using a front or rear projection system or other like display such as those suitable for multiple participants such as in a classroom, conference room, or other forum.

Similarly, input device 101 can be used to control various aspects of other application programs as well. For example, for drafting letters, taking notes and so on, word processing, spreadsheet and other programs can be included with computer 103 as well. Voice recognition software can also be included with computer 103 to allow the conversion of audible speech patterns into computer recognizable text for word processing and other operations. Thus, for example, where, as described below, input device 101 is used for audio recording, voice recordings of meetings, speeches, or other audio content can be captured by input device 101 and converted into machine-readable text such as, for example, as ASCII characters. Also, control logic for voice recognition can be provided in input device 101 to allow such functionality to be performed at the input device. Similarly, audio recordings of voice music or other audio content can be captured and recorded in .wav or other audio files for playback at the input device 101 or on computer device 103.

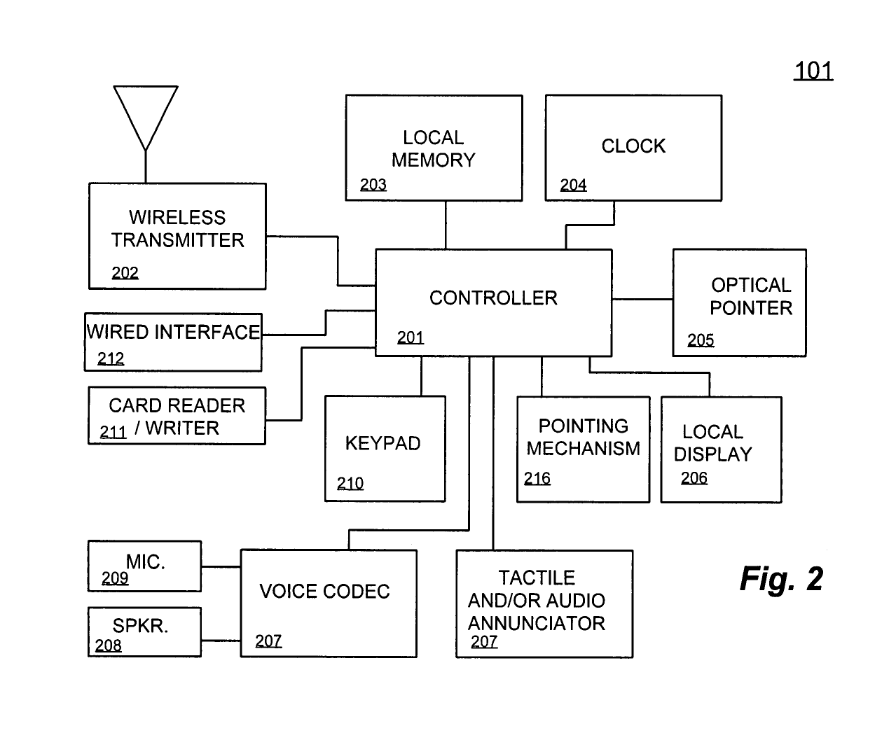

FIG. 2 is a high level block diagram illustrating one example embodiment of input device 101. A controller 201 is provided to control the features and functionality of the input device 101.

A communication interface is also desirably provided to facilitate communication of user input to computer 103. This communication interface can be wired or wireless. A wireless transmitter 202 can be included to transmit control signals or other data and information via air interface 105 to wireless interface 102. Such information can be used for interaction with an operating system, application program or other software running on computer 103. A wired interface 212 can alternatively or additionally be included to allow transfer of data to and from computer 103 via a cable or other wireline connection. For example, this interface can connect to computer 103 via a USB port, a network connection, an RS-232 port, a parallel interface or via any other hardwired communication interface.

Also included in this example embodiment are a local memory 203 operatively connected to controller 201. Local memory 203 can be implemented using any form of memory, and can be used to store data relating to computer 103 activities such as data for presentations or other applications, audio, video and other content recordings as described below, and other data or information as may be useful. Memory 203 can also be provided to store program instructions and computational results to assist controller 201 in performing its designated functions. In one embodiment, memory 203 is implemented as random access semiconductor memory, in either volatile or nonvolatile form, although additional and alternative storage devices can be used as would become apparent to one of ordinary skill in the art after reading this description.

A clock 204 can also be provided to provide timing information to controller 201. The clock signal can be used, for example, to synchronize different parts of the device and to provide timing information for operation of controller 201. A clock 204 can also be provided to provide timing information for the timing features of the invention as described below.

A removable storage interface such as a card reader/writer 211 can also be provided and is operatively connected to controller 201. Removable memory cards, such as Secure Digital®, Sony® Memory Stick®, or Compact Flash®, for example, can be used in card reader/writer 211 for additional memory storage for data and other information, including data relating to applications (for example, presentations), and content information recordings. Such memory cards can typically be physically transferred among card readers/writers associated with various computers to facilitate the transfer of data. Advantageously, files stored on such cards can be in various formats to avoid the need to install special software drivers on such computers.

Controller 201 can be actuated by user interface mechanisms such as buttons or a keypad 210 and pointing mechanism 216. The pointing mechanism 216 can, in some embodiments for example, be a mouse, a trackball, a touchpad, a joystick, a rocker switch, a scroll wheel, an optical sensor (laser or otherwise) or other mechanism. Inertial sensors can also be used for pointing mechanism 216. Pointing mechanism 216 accepts user input such as, for example, movement of input device 101 (for example, moving a mouse across a surface) or actuation of input device 101 (for example, movement of a trackball, dialing of a scroll wheel, and so on). This input is converted into control signals on to which positional information can be encoded. This can be used to, for example, control cursor movement and position on the screen.

The keypad 210 can include one or more buttons, switches or other user actuated mechanism to operate the device. Such mechanisms are generally referred to as keys. In one embodiment, such keys can be specifically dedicated to actuate particular functions. In other embodiments, the keypad can have at least some keys that are software defined, that actuate functions depending on operational context. For example, the function of a key may change depending on what operating mode the handheld device is in, for example modes may be defined such as mouse mode, presentation mode, audio mode and so on. As another example, a presentation mode may have submodes such as a conduct-presentation mode, a record-presentation mode an edit-presentation mode and so on, as described below.

Local display 206 can comprise LCD, LED, or other optical display components. In one embodiment, the local display is used to display time information relating to a presentation, a recording or other activity. As a further example, where the display 206 is used to show time information for a presentation, it can show a value for total time remaining for a presentation, allocated time remaining for a given presentation element (e.g., slide) being presented, total elapsed time, current-slide elapsed time, average-time per slide so far, average time per slide remaining, and so on. The values shown can be numerical, in the form of digits, and/or graphical in the form of icons, bar graphs, histograms or other graphical information. Simple displays such as numerical LCD's or simple LED's can be used as can more complex matrix displays using LCD or other technologies.

In one simple example embodiment, a pure numerical LCD display shows the time information. In another simple embodiment, a traffic-light display, that is an arrangement of green light, yellow light, and red lights (LEDs or otherwise) arranged similar to the configuration of a traffic light, can be used to show time remaining for a presentation (either total time or time per slide, for example), or in terms of memory space available for an audio or other content recording. Rather than being arranged in a row, the traffic light display can be arranged in any pattern and can also be configured as a single LED or other light source that is capable of changing colors, from among green, yellow, and red, for example.

Additionally, a tactile and/or audio annunciator 214 can be provided to signal timing and other information to the user. Tactile annunciation, in some embodiments can consist of, for example, an electromechanical vibrator that, when actuated, can be sensed by a the user holding the input device 101. Audio annunciators can comprise beeps or other tones, voice prompts or other audio, played through a speaker 208, or an additional audio transducer, to advise a presenter regarding the timing information. For example, an annunciator may signal that it is time to advance to the next presentation element (for example, time to advance to the next slide), that the user is nearing the end of his/her allotted presentation time, that recording memory is nearing capacity, and so on.

The input device 101 can be used to record and playback audio information or other content information. Thus a microphone 209 and speaker 208 can be included with the input device for capturing and playback of audio content. Likewise, a video capture device such as, for example, a CCD, CMOS or other image sensor or other video capture mechanism can be used to capture still or moving video images, and a display can be included with input device 101 for playback of video content.

The term “recording” in its various forms (including in the verb form, “record”) is used herein to refer to capturing and storing content information, regardless of whether the information is stored locally at input device 101 or remotely (e.g., on a computer 103). A voice codec 207 or other like functionality can be provided to connect microphone 209 and speaker 208 with controller 201. Voice codec 207 can be included to digitize audio received by microphone 209, and perform digital-to-analog conversion for audio to be played through speaker 208. In some embodiments, microphone 209 and speaker 208 may comprise the same audio transducer. Captured audio information or other captured content can be stored locally at input device 101 and can be transferred to the computer for storage or use at the computer. Local storage can be provided, for example, using card reader/writer 211, local memory 203, or other storage mechanism. Additionally, captured content can be streamed or otherwise provided to the computer 103 or other external device, and recorded at or used by that device, regardless of whether the captured content information is stored locally at input device 101. Keypad 210, pointing mechanism 216 or other user input mechanism can be used to control the capture and record features for the content recording, including capture, and local or remote storage of the captured content. For example, in a streaming mode, these input mechanisms can be used to control Windows® recording functions or other like features of software on computer 103. Also, an operating system or application program running on computer 103 may provide instructions to the pointing device 101 to configure and control the recording features. Additionally, a vox or other voice actuated relay or switch can be provided to turn on and off the recording features automatically.

Controller 201 connects with voice codec 207 to control voice codec 207 to record or play audio data that can be stored in local memory 203 and/or a memory card in card reader 211, and to play audio data received from the computer 103. Although not illustrated, video capture, record and playback capabilities can be implemented as well as would be apparent to one of ordinary skill in the art after reading this description. Thus, the input device can be used to record and playback various forms of content information including audio and video content. In order to increase the duration of audio or video that can be recorded, various compression techniques can be used with the digitized content, for example without exclusion: MP3, Microsoft® WMF, MPEG, and many others that are well known to one of ordinary skill in the art.

Optical pointer 205 such as a laser pointer or other mechanism can be included and can in some embodiments be actuated through controller 201, or in other embodiments directly controlled by a user-actuated switch. Optical pointer 205 can be a laser, or other type of optical projection mechanism for projecting a pointer on a screen. The optical pointer 205 can be actuated by controller 201 responsive to an actuation of keypad 210, or it may be actuated by a separate switch. The switch can be part of keypad 201, or a separate switch in an ergonomic position on the handheld device. The optical pointer 205 can be a miniature optical projector, using an incandescent or LED light source. In other embodiments the optical pointer can be a semiconductor diode or other laser. For example, GaAlAs semiconductor diode lasers can be used to provide red projected light or GaN semiconductor diode lasers can be used to provide green or blue projected light. The semiconductor diode laser can operate in continuous and/or pulsed mode when actuated.

As would be apparent to one of ordinary skill in the art after reading this description, the components described above with reference to FIG. 2 can be implemented using various forms of control logic. As used in this document, the term “control logic” can be used to refer to hardware, software, or a combination thereof, configured to perform the described functions. Thus, control logic can include software, one or more processors, ASICs, PLAs and other logic devices, as well as mechanisms or components configured to implement the desired features and functions described herein. The functions described can be implemented using either dedicated or shared elements of control logic.

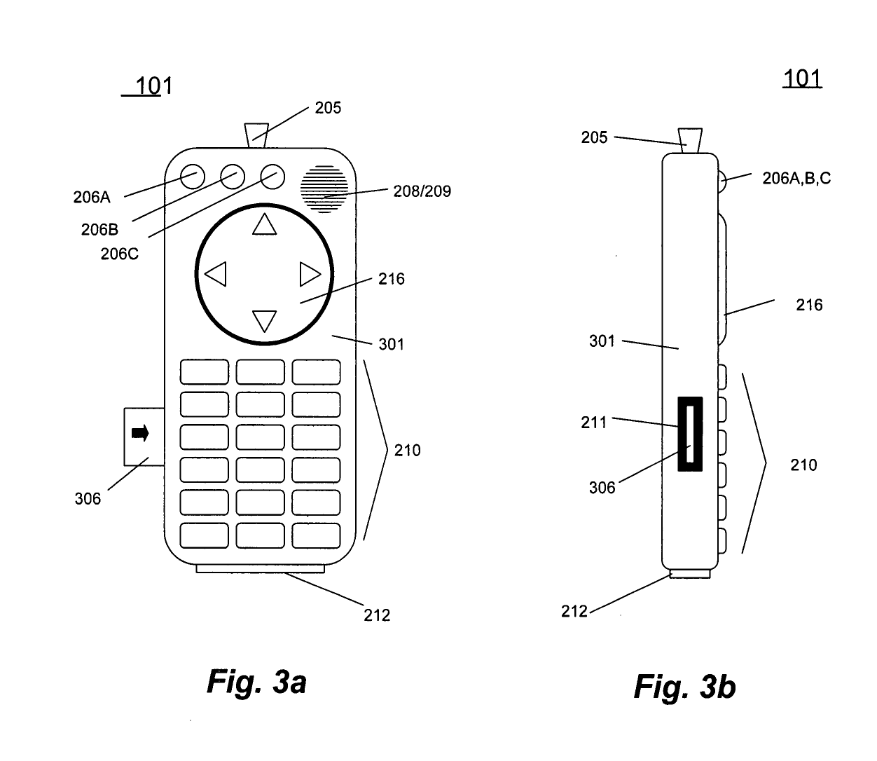

FIGS. 3a and 3b are diagrams illustrating front and side views, respectively, of one embodiment of an example input device 101. The example input device 101 illustrated in FIGS. 3a and 3b include a plurality of input keys 210, pointing mechanism 216, a memory card interface 211, an antenna 205, a display 206, and a speaker/microphone assembly 208, 209. In the illustrated example, keypad 210 comprises a plurality of buttons or keys that can be depressed by the user to cause input device 101 to send certain control signals to computer 103 via the wired or wireless interface. Although the buttons or keys of keypad 210 are arranged in a matrix fashion, other suitable arrangements are contemplated and within the scope of the present invention. For example, in another embodiment, one or more keys 210 are arranged around the perimeter of pointing mechanism 216 such that the user can alternate between pointing mechanism actuation and button actuation within a short range of motion.

The example illustrated in FIG. 3 shows a four- or eight-way rocker switch used as the pointing mechanism 216. Thus, for example, the user can control the x-y position or location of a pointer, such as a mouse pointer on the screen. Position in a given direction can be altered by depressing the multi-way rocker switch in the corresponding direction. A scroll-lock button can also be included to allow the multi-way rocker switch to be used as a scrolling mechanism as well. As would be apparent to one of ordinary skill in the art after reading this description alternative pointing devices can be used including, for example, touch pads, trackballs, scroll wheels, optical motion detectors, and any of a number of user-actuated pointing mechanisms.

The example display 206 illustrated in FIG. 3 is a three-piece status indicator comprised, for example, of three LED's 206A, 206B, and 206C. Thus, in this example embodiment, the LED's can be arranged as described above in the traffic light configuration utilizing a green, yellow, and red LED to display time or other information as a function of urgency or importance. Alternatively other colors can be used or a monocolor arrangement can be implemented where the number of LED's lit is used to indicate remaining time or other metric. Of course, as described above with reference to FIG. 2, display 206 can be implemented utilizing any of a number of different configurations including alphanumeric and graphical displays.

FIG. 3 also illustrates an example positioning of a speaker/microphone assembly 208/209 that can be used to provide audio annunciation of timing or other information to the user as well as to accept voice and other audio signals for recording by input device 101. The example illustrated in FIG. 3 also includes both a wireless interface 205 and a hardwired interface 212 to provide flexibility in making a communication connection with computer 103 and a card interface 211 suitable for accepting a memory card 306 for data and information transfer between devices.

Pointing mechanism 216 in the illustrated example is a multi-way rocker switch for accepting user input to control pointer position or for other operations. Keypad 210 is an array of buttons that can have dedicated and/or software defined keys. 208/209 is a speaker/microphone assembly. Indicators 206A, 206B, and 206C are status indicator LED's, for example in the “traffic light” green, yellow, and red configuration. Memory card 306 is an optional external memory device that is shown as inserted in memory card reader slot 211. Interface 212 is a wired interface that can be used to provide a hard wired connection to computer 103 via any of a variety of standard or non-standard connections. Optical pointer 205 is an optical projecting device such as a laser pointer or other mechanism used as an optical pointer that can be actuated independently of the applications or operating system running on computer 103.

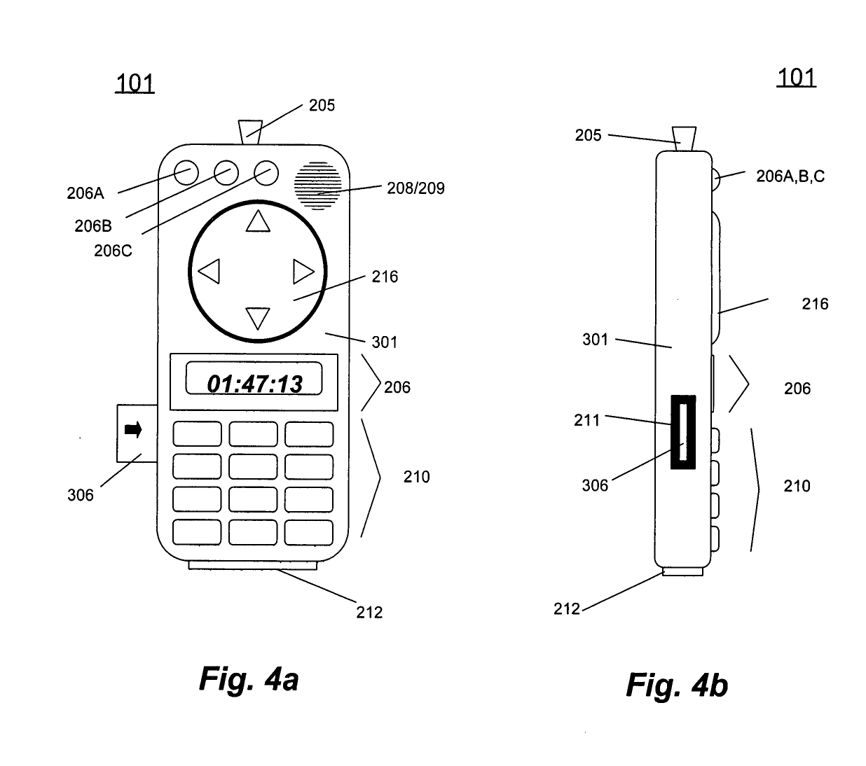

FIGS. 4a and 4b illustrate a handheld controller according to another embodiment of the invention. This embodiment is similar to the embodiment of FIGS. 3a and 3b, except that it also has numeric display 206. Numeric display 206 can, for example, comprise LED's, LCD's or other number indicators. The numeric display can be used to show total time remaining for a presentation, total time remaining for a particular presentation element, total time remaining for a particular group of presentation elements, elapsed time, per slide average elapsed time, or various combinations of the above. In further embodiments, the display can be alphanumeric or a graphical to display additional information or to display information in different formats. The embodiment illustrated in FIGS. 4a and 4b illustrates the numeric display 206 in addition to LED's 206A, 206B, and 206C. Alternatively, this numeric or other display can be provided in place of LED's 206A, 206B, and 206C. As will be apparent to one of ordinary skill in the art after reading this description, any combination of displays or annunciation mechanisms can be provided with the input device 101.

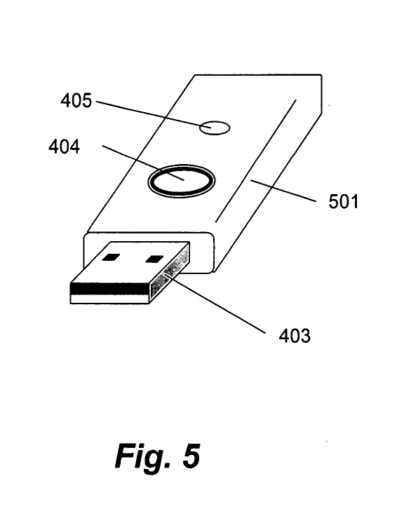

FIG. 5 is an exemplary physical embodiment of wireless interface 102, showing a circuit housing 501, a USB connector 403, a connect button 404 and a status display 405. In some embodiments, wireless interface 102 may be built onto a computer 103 in an integrated fashion. In alternative embodiments, however, an external fob, dongle, or other device can be utilized to provide a wireless interface capability that may not otherwise be included with computer 103. FIG. 5 is a diagram illustrating an example physical embodiment of such an external wireless interface that can be included to facilitate wireless communications with computer 103. Referring now to FIG. 5, in this example, the device is in the form of an external fob that can include a USB connector 403 to interface with a USB port of computer 103. Alternative interface mechanisms can be used such that it is not necessary to rely on a USB port. The housing 501 also includes a connect button 404 and a status indicator 405 such as an LED or other status mechanism.

Connect button 404 actuates a signal seeking process in control logic 402 that directs wireless receiver 401 to seek a signal from input device 101. When such a signal is received, and connection is established, status display 405 indicates so. Status display 405 can be a LED, LCD, incandescent lamp, or the like, that is illuminated or extinguished when a handheld device signal has been detected.

In operation, the handheld device can function as an ordinary pointing device (such as, for example, a mouse, a trackball, touchpad or trackpad) with additional buttons to control a computer's operation in general. However, the handheld device can also function as an optical projection pointer and a timer for use in presentations. Additionally, the handheld device can have audio and video content recording capabilities for a presenter to record notes or other information or content during a presentation.

The timer in the handheld device can be set to measure one or more timing events associated with a given application. In addition to simple time measurements, the timer can be configured to compute timing events as well. For example, consider a presentation application. In this application the timer can configured to count down from (or count up to) a total allocated presentation time in some embodiments. In a count-down timer mode, for example, the timer may be set for the allotted presentation time, and countdown toward zero as the presentation progresses. In count-up timer mode, for example, the timer may start at zero or other reference time, and simply count up as the time elapses. As a further example, in the count-up mode, buttons 210 or other input mechanisms can be used to start, stop and reset the elapsed-time timer.

As additional examples in the presentation application, the timer can be set to measure a per-element dwell time, a running average time for the presentation elements, time remaining in a presentation, time spent in the presentation so far, an estimate of how far ahead or behind the presenter is based on average times or based on time information obtained in the leaming mode (described below), presentation timing milestones (for example, five minutes remaining), and other timing events as may be appropriate or desired. These examples in the presentation application serve to illustrate exemplary timing events that can be measured or computed. After reading this description, it will become apparent to one of ordinary skill in the art how to measure or compute other timing events in other applications as well.

In some embodiments, a single timer display can be provided with a toggle function to allow the user to scroll through the various time modes thus alternatively displaying elapsed time, time remaining, average time consumed for each presentation element or groups of presentation elements, average time per presentation element remaining, and other time parameters as may be utilized. Additionally, in other embodiments, multiple displays can be provided such that two or more of the time elements can be displayed simultaneously to the user. Also, as discussed above, bar graphs, histograms, or other graphical information can be presented on a display to allow the user to quickly see at a glance the various time parameters that may be associated with his or her presentation. The time display and graphical information can also be implemented so as to change color thereby providing the operator at a glance with information concerning the amount of time remaining. Thus, for example, where a user is running on time or ahead of time with his or her presentation time information may be displayed in a given color such as, for example, green. However, should the user begin to fall behind the allotted time the display information may change from green to yellow such that the user knows to pick up the pace or otherwise advance more quickly through the presentation materials. Should the user fall significantly behind schedule or be nearing the end of the presentation, the display can switch to another color such as, for example, red, thus indicating to the user that he or she should pick up the pace or even summarize his or her presentation for a conclusion.

Keeping with this theme, in one embodiment, the user can program input device 101 either directly or via computer 103. The programming can be used to control the features and functionality of input device 101 as well as its operation. Thus, for example, the user may program an average time per presentation element and also program the device to change display color or otherwise alert the user when designated thresholds of tardiness or delay are detected. Similarly, the user can program the device to warn the user when there is a predetermined amount of time remaining such as, for example, 10 minutes remaining, 5 minutes remaining or other amount of time. Thus, in this example, the user may program the device to generate one warning such as a yellow display or a yellow LED when 10 minutes are remaining and a red display or LED when 5 minutes are remaining.

Thus, the user may input directly into input device 101 the allotted time, the number of presentation elements in his or her presentation, and other pertinent information to allow input device 101 to facilitate timing of the presentation. For example, if the user enters the allotted time and the number of slides, input device 101 can compute the average time per slide that is allotted for the presentation. Because in one embodiment input device 101 is used to advance through the presentation, input device 101 can keep track of the user's progress through the presentation and thus use the display or other annunciation mechanism to alert the user if he or she is ahead of or behind the allotted time in the presentation.

In other embodiments, this information can be entered into the application program used to generate the presentation and then downloaded to input device 101 to facilitate timing operations. Thus, for example, the application program may allow the user to enter the total amount of allotted time and average time per slide, or a given amount of time for each slide such that this information is maintained by the application program and then transferred to input device 101 for the presentation. Additionally, the processing and other operations used to keep track of time and to alert the user can be performed by the application program running on computer 103 and simple signals sent to input device 101 to alert the user during the presentation. Thus, in this embodiment, more of the control logic (in this embodiment, more than likely software) for the features for functionality of the invention can be included with the application program thus simplifying the implementation of input device 101. This may bring the added advantage of reducing battery consumption, complexity and cost associated with input device 101.

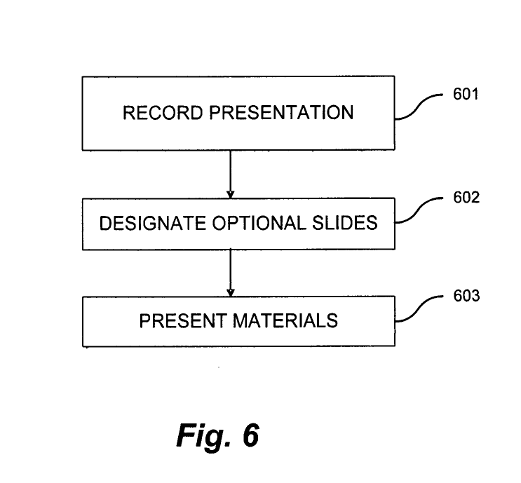

As described above, the time limits or other information can be entered manually, through input device 101 or via computer 103. In other embodiments, the time limits can be learned by actually running through a presentation using the handheld device to advance the slides being presented. FIG. 6 is an operational flow diagram illustrating a process for leaming timing information associated with a slide presentation in accordance with one embodiment of the invention. Referring now to FIG. 6, in a step 601, the user steps through a prepared presentation using input device 101 to advance the slides. In this example embodiment, the presentation elements are slides in a presentation program. This step can be done simply to allow input device 101 to count the number of slides for the presentation. However, in another embodiment, the user can actually perform a dry run of the presentation allowing input device 101 not only to capture the number of slides but the amount of time spent on each slide as well as the total time for the presentation. In one embodiment, the actual time can be compared with a target time to determine whether the user needs to cut out presentation materials or advance more quickly through his or her materials. Thus, in this embodiment, a target time can be entered into input device 101 and additional dry runs conducted to allow the user to perfect his or her timing of his or her presentation, to edit the materials, or otherwise alter the approach prior to the actual presentation.

In a step 602, in one embodiment, the user is provided with the option of designating one or more slides as optional slides. That is, the user may wish to designate one or more slides that he or she is willing to skip in the presentation should time run short. Thus, in this embodiment, where time is running low the system can be programmed so as to automatically skip these designated optional slides thus allowing the user to keep on track for the presentation. In one embodiment, this designation can be done with and stored in input device 101 allowing input device 101 to control the skipping operation. For example, if certain slides are designated as optional, and input device 101 recognizes that time is running beyond a given threshold, input device 101 may send the appropriate control signals to computer 103 to advance past the designated slides to be skipped. In an alternative embodiment, this control can be embedded in computer 103 and its application program or operating system such that the system knows to skip the designated optional slides when a time threshold is exceeded. Thus, with input device 101 and computer 103 appropriately set up with presentation and timing information, in a step 603 the user can present his or her slideshow.

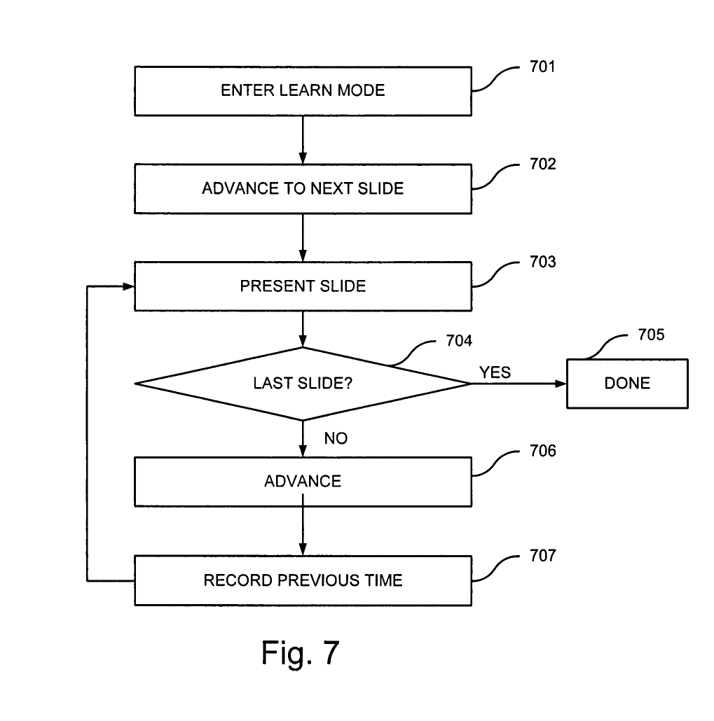

FIG. 7 is an operational flow diagram illustrating in more detail an example process for learning presentation timing in accordance with one embodiment of the invention. Referring now to FIG. 7, in a step 701 the user causes the device to enter the record presentation mode. As described above, the recording or learning mode can be accomplished within input device 101 or the application program running on computer 103 or a combination of the two, depending on the implementation. In a step 702, the user using input device 101 advances to the next presented slide. In a step 703, the user walks through his or her dry run of that slide and if there are additional slides to be presented as illustrated by a step 704 advances to the next presented slide. At this time, the device can now calculate the dwell time for the previous slide and record that dwell time in memory. This is illustrated by a step 707. The operation returns to step 703 where the presenter gives his or her dry run presentation for the current slide advances to the next slide and the dwell time is again recorded. This continues until there are no more slides in the presentation (step 704) and the record presentation mode is exited in a step 708. This process for learning time information by manually advancing through the slides can be used to set total presentation time, per-slide presentation time goals, timers for replay, and other time information, which can then be used by pointing device 101 or computer 103 to prompt or inform the user using displays 206 and/or annunciators 208 during the actual presentation or during subsequent practice runs. In this way, by doing a “dry run” training session in the learning mode, the handheld controller can be taught display intervals or dwell times for each slide in a presentation and other timing information.

Timing information for slides in a presentation can be stored in local memory 203 and/or a removable memory card in card reader/writer 211. Alternatively, it can also be transferred to a computer via wired interface 212 and/or wireless transmitter 202 for more archival storage. As yet another alternative, it can be directly entered into computer 103 by the user. For example, the presentation application may be configured to accept user input of total time, average per-slide time, individual slide times, topic times (or section times), and so on. Advantageously, in some embodiments, timing information files can also designate corresponding presentation file designations.

When a presenter presents, the recorded, or pre-set time intervals for the presentation and the per slide display time can be automatically accessed and advanced as the presenter advances slides being displayed using the handheld device. The handheld device can be set to alert the user to excess display time for a slide, or at benchmark times during a presentation, such as “three minutes left,” for example. The handheld device can signal the presenter using optical, audio, or tactile cues, as described above.

The power source for the handheld unit can be primary (non rechargeable) or secondary (rechargeable) cells. Primary cells can include, without exclusion, alkaline, silver oxide, or lithium AA, AAA, AAAA, or various button cells. Secondary cells can include, without exclusion, Ni-Cd, Ni-MeH, or lithium ion cells. Typically, a charger would be supplied for handheld devices using secondary cells. Wireless interface 102 can in one embodiment be powered by a host computer, over USB interface 403.

In yet another embodiment, input device 101 can include audio and video recording capabilities as described above with reference to FIG. 2. These recording capabilities can be used to provide such features and functionality for input device 101 in a number of settings. For example, as a presentation tool the audio recording capability can be used by the user to record audience questions or comments for storage and later playback. Thus, in this manner, the user would not need to write down or try to remember audience questions that may require follow-up research and answers. In this embodiment, a question can be recorded by the input device and the audio information stored directly in local memory 203 or communicated to computer 103 for storage at computer 103. This question can be later recalled by the user such that appropriate answers can be obtained or the presentation materials updated for subsequent presentation sessions.

As stated above, the audio recording capability can include speech recognition capability such that the questions or other audio information can be recorded to a word processing, presentation, or other program for use of and later recall by the user. Additionally, the user may wish to record speaker notes or other comments for subsequent recall and may use speech recognition capabilities to incorporate these comments directly into the presentation or other materials. Such speech recognition capabilities may be provided in either the input device 101 or with a computer or other device with which it interfaces, or both.

In yet another application, the audio recording functionality can be used to provide similar features and advantages to a user. For example, where input device 101 is a pointing device used to provide a human interface to a computer during a meeting, input device 101 can be used to record meeting minutes or other dialogue or commentary made during the meeting. Thus, input device 101 can serve the additional purpose of a microphone able to pick up speech or other audio information during a meeting and capture that information either within input device 101 or directly onto computer 103 as described above. In a similar fashion, input device 101 can simply serve as a microphone for dictation, IP telephone calls or other like operations, whether or not local or remote content storage is applied. Input device 101 can be provided with sufficient memory, whether internal or removable, to store desired amounts of recorded audio or video content for subsequent playback or for downloading to a computer or other device. Additionally, input device 101 can be configured to stream content information to computer 103 or other external device, reducing or obviating the need for local storage.

Additionally, input device 101 can be provided with scanning capabilities such that it can scan images and text, again either into local storage or for direct transfer to computer 103. This capability can be coupled with optical character recognition programs to allow scanning of text documents into word processing programs as well to allow the scanning of images into graphic programs.

While various embodiments of the present invention have been described above, it should be understood that they have been presented by way of example only, and not of limitation. Thus the breadth and scope of the present invention should not be limited by any of the above-described exemplary embodiments, but should be defined only in accordance with the following claims and their equivalents. Additionally, the invention is described above in terms of various exemplary environments, embodiments and implementations. It should be understood that the various features and functionality described in one or more of the individual embodiments, environments or implementations are not limited in their applicability to the particular environment, embodiment or implementation with which they are described, but instead can be applied, alone or in some combination, to one or more alternative environments, embodiments or implementations of the invention, whether or not such environments, embodiments or implementations are described and whether or not such features are presented as being a part of a described environment, embodiment or implementation.

Terms and phrases used in this document, and variations thereof, unless otherwise expressly stated, should be construed as open ended as opposed to limiting. As examples of the foregoing: the term “including” should be read to mean “including, without limitation” or the like; the term “example” is used to provide exemplary instances of the item in discussion, not an exhaustive or limiting list thereof; and terms and phrases such as “known,” “apparent to one of skill in the art,” “conventional,” “traditional,” “normal,” “standard,” and terms and phrases of similar meaning should not be construed as limiting the item described to a given time period or to an item available as of a given time, but instead should be read to encompass conventional, known, apparent, traditional, normal, or standard technologies that may be available now or at any time in the future. A group of items linked with the conjunction “and” should not be read as requiring that each and every one of those items be present in the grouping, but rather should be read as “and/or” unless expressly stated otherwise. Likewise, a group of items linked with “or” should not be read as requiring mutual exclusivity among the items in the group, but rather should be read as “and/or” unless expressly stated otherwise.

What is claimed is:

1. A computer pointing device, comprising:
a housing;
a pointing mechanism at least partially within the housing and configured to accept user input and to generate a first control signal to control a pointer position on a display of the computer;
at least one input key at least partially extending from the housing and configured to generate a second control signal to provide an instruction to an application running on the computer;
an audio transducer configured to receive audible information and to convert the audible information into first electrical signals;
an audio encoder within the housing and electrically coupled to the audio transducer, the audio encoder configured to encode the electrical signals into a digitized representation of the received audible information;
a memory device electrically coupled to the audio encoder and configured to store the digitized representation of the received audible information;
an audio decoder configured to decode the digitized representation into second electrical signals; and
a speaker, connected to the audio decoder and configured convert the second electrical signals into an audible stream of information.

2. The computer input device of claim 1, further comprising a display on the computer input device configured to provide time information to the user of the computer input device.

3. The computer input device of claim 2, wherein the display comprises at least one of an alphanumeric display, a graphical display, a numeric display, and a traffic light display.

4. The computer input device of claim 1, wherein the pointing mechanism comprises at least one of a trackball, touchpad, joystick, scroll wheel, an optical sensor and an inertial sensor.

5. The computer mouse of claim 1, further comprising at least one of a wired and a wireless communication interface to the computer.

6. The computer mouse of claim 1, wherein the speaker and the audio transducer comprise the same transducer.

7. A computer input device, comprising:
a plurality of input keys configured to permit user interaction with one or more application programs running on a computer;
a user actuated pointing mechanism configured to allow a user to control a position of a pointer on a display screen of the computer; and
a recording module configured to record content information for later playback.

8. The computer input device of claim 7, further comprising at least one of a wired and wireless interface to the computer.

9. The computer input device of claim 7, further comprising a display on the computer input device configured to provide time information to the user of the computer input device.

10. The computer input device of claim 9, wherein the display comprises at least one of an alphanumeric display, a graphical display, a numeric display, and a traffic light display.

11. The computer input device of claim 7, wherein said content information comprises at least one of audio and video information.

12. The computer input device of claim 7, further comprising memory configured to store content information locally at the computer input device.

13. The computer input device of claim 12, wherein the memory comprises at least one of internal memory and a removable memory device.

14. The computer input device of claim 7, wherein the recording module is configured to capture the content information and provide the captured content information to a computer for storage at the computer.

15. A computer input device to control operation of computer, the input device, comprising:
a user input mechanism configured to accept user input at the pointing device;
first control logic disposed within the pointing device and configured to convert the user input into first control signals operable to control one or more aspects of the operation of the computer;
second control logic configured to provide the first control signals to the computer; and
third control logic configured to capture content information for recording.

16. The computer input device of claim 15, wherein said second control logic comprises at least one of a wired and wireless interface to the computer.

17. The computer input device of claim 15, wherein the user input mechanism comprises at least one of a trackball, touchpad, joystick, scroll wheel, an optical sensor and an inertial sensor.

18. The computer input device of claim 15, wherein said second control logic is further configured to provide recorded content information to the computer.

19. The computer input device of claim 15, wherein the third control logic comprises an audio encoder configured to digitize captured content information.

20. The computer input device of claim 15, wherein the third control logic comprises an audio transducer.

21. The computer input device of claim 15, further comprising a display on the computer input device configured to provide time information to the user of the computer input device.

22. The computer input device of claim 15, wherein said content information comprises at least one of audio and video information.

23. The computer input device of claim 15, wherein said third control logic is configured to provide the captured content information to a computer for recording.

24. The computer input device of claim 15, further comprising memory configured to store store content information locally at the computer input device.

25. The computer input device of claim 24, wherein the memory comprises at least one of internal memory and a removable memory device.

26. A computer input device for controlling operation of computer, comprising:
means for accepting user input at the pointing device;
means for converting the user input into control signals operable to control one or more aspects of an operation of the computer;
means for providing the control signals to the computer; and
means recording content information via the pointing device.

27. The computer input device of claim 26, wherein said content information comprises at least one of audio and video information.

28. The computer input device of claim 26, further comprising means for storing recorded content information at the pointing device.

29. The computer input device of claim 26, further comprising means for providing recorded content information to the computer.

30. The computer input device of claim 26, wherein said means for recording comprises means for capturing the content information and providing the captured content information to a computer.

31. A method of using an input device to control a computer, comprising:
accepting user input via user actuation of input mechanisms on the pointing device;
converting the user input into control signals operable to control one or more aspects of the computer;
providing the first control signals to the computer; and
recording content information via the input device.

32. The method of claim 31, further comprising the step of storing the recorded content information at the input device.

33. The method of claim 31, further comprising the step of recording video information via the pointing device.

34. The method of claim 31, further comprising the step of communicating recorded content information to the computer.

35. The method of claim 31, further comprising the step of encoding captured content information.

36. The method of claim 31, wherein the content information comprises at least one of audio and video information.

37. The method of claim 31, further comprising the step of capturing the content information and providing the captured content information to a computer.
